(19) United States
(12) Patent Application Publication
(10) Pub. No.: US 2021/0162662 A1
(43) Pub. Date: Jun. 3, 2021

(54) ANOMOLOUS NOZZLE DETERMINATION BASED ON THERMAL CHARACTERISTIC

(71) Applicant: Hewlett-Packard Development Company, L.P., Spring, TX (US)

(72) Inventors: Sunil Kothari, Palo Alto, CA (US); Tod Heiles, Vancouver, WA (US); Gary J Dispoto, Palo Alto, CA (US)

(73) Assignee: Hewlett-Packard Development Company, L.P., Spring, TX (US)

(21) Appl. No.: 17/047,297

(22) PCT Filed: Aug. 23, 2018
(86) PCT No.: PCT/US2018/047653

§ 371 Date: Oct. 13, 2020

(51) Int. Cl. B29C 64/209; B29C 64/393

(52) U.S. Cl. CPC B29C 64/209; B33Y 30/00; B29C 64/393

(57) ABSTRACT

An example system includes an array of nozzles to deposit a print material for printing a three-dimensional object, a thermal sensor to determine a thermal characteristic at multiple locations of the print material, and a controller. The controller includes a gradient identification portion to identify a location on the print material having a gradient of the thermal characteristic being greater than a predetermined threshold. The controller further includes a nozzle identification portion to identify a nozzle associated with the identified location as an anomalous nozzle.

### BACKGROUND

Three-dimensional (3D) printers may operate with carriages performing various tasks. For example, one carriage may deposit material in layers, and another carriage may apply energy or agents to selectively fuse the material. Each carriage may include nozzles to deposit the material (e.g., build material or agents).

### BRIEF DESCRIPTION OF THE DRAWINGS

For a more complete understanding of various examples, reference is now made to the following description taken in connection with the accompanying drawings in which:

FIG. 1 illustrates a block diagram of an example system for anomalous nozzle determination;

FIG. 2 illustrates another example system for anomalous nozzle determination;

FIG. 3 illustrates a block diagram of another example system for anomalous nozzle determination;

FIG. 4 is a flowchart illustrating an example method for anomalous nozzle determination; and

FIG. 5 illustrates a block diagram of an example system with a computer-readable storage medium including instructions executable by a processor for anomalous nozzle determination.

### DETAILED DESCRIPTION

As noted above, three-dimensional (3D) printing is performed with nozzles to deposit various materials (e.g., build material or fusing agents). Anomalies or defects in any nozzle can lead to defects in the printed 3D object. Defective nozzles may lead to gaps or weaknesses in the printed object. Identification of the defective nozzles can facilitate identification of defective 3D objects or allow for remediation of the defective nozzles.

Various examples described herein provide for identification of a nozzle, or a group of nozzles, in a three-dimensional printer that may be defective, performing sub-optimally, in need of maintenance or otherwise anomalous. Following depositing of a printing material by an array of nozzles, a thermal sensor may detect a thermal characteristic (e.g., temperature) at various locations of the print material. The printing material may be a layer of build material or a fusing agent deposited at selected locations onto the build material. In various examples, the temperature may be detected at an array of points on the printing material. Under nominal or normal operation, the temperature at the various points is substantially uniform. Thus, when a gradient in the temperature is detected and is above a predetermined threshold, the location of that gradient may be associated with a particular nozzle or a group of nozzles in the array of nozzles. For example, if the detected temperature at one location is more than 2° C. above or below the temperature at points around that location, the location may be associated with a nozzle, and that nozzle may then be indicated as an anomalous nozzle. In various examples, indication of the anomalous nozzle may initiate remediation of the nozzle. The remediation may include any of a variety of actions, examples of which are described below.

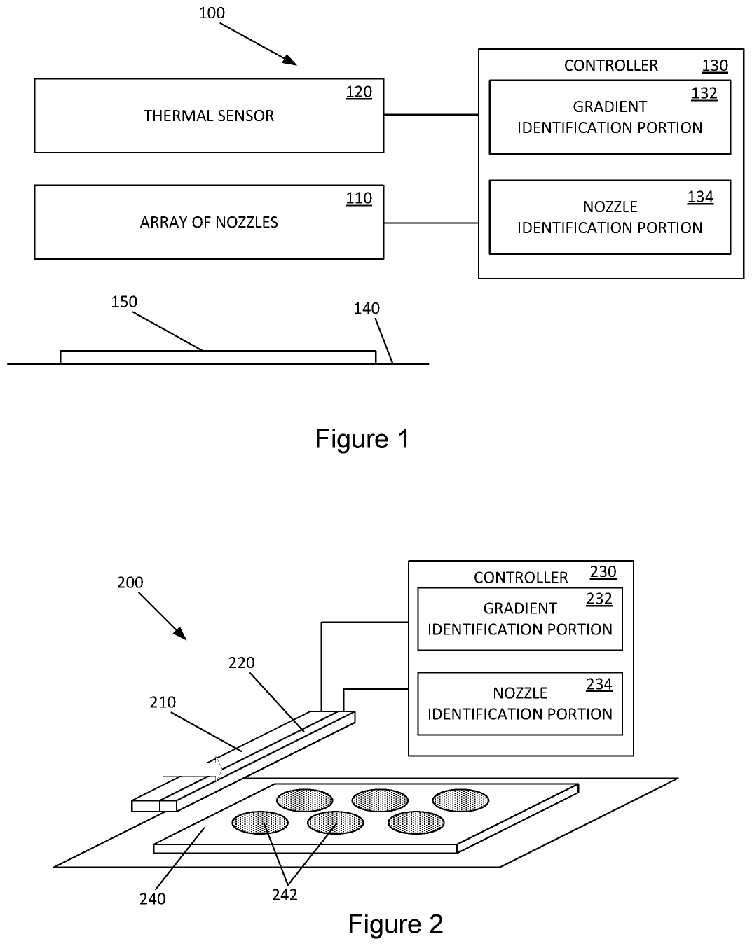

Referring now to the Figures, FIG. 1 illustrates a block diagram of an example system 100 for anomalous nozzle determination. The example system 100 includes an array of nozzles 110 that may be part of a three-dimensional (3D) printer. In various examples, the 3D printer may use any of a variety of 3D printing technologies including, but not limited to, multi-jet fusion (MJF), fused deposition modeling (FDM), or selective laser sintering (SLS). The 3D printing may include depositing a layer of build material (e.g., 3D printing ink or powder) and a fusing agent at selected locations to fuse the build material. In various examples, the array of nozzles 110 may be mounted on a carriage that sweeps a build stage along one axis (the X axis), such as the build stage 140 of FIG. 1, and deposits successive layers of build material, such as the build material 150, or the fusing agent at selected locations of the build material 150. Thus, in various examples described herein, the array of nozzles 110 may be used to deposit either the layer of build material 150 or the fusing agent at selected locations.

The example system 100 of FIG. 1 further includes a thermal sensor 120. The thermal sensor 120 may be mounted with the array of nozzles 110, such as on the same carriage as the array of nozzles 110. In some examples, the thermal sensor 120 may be mounted in any of a variety of other locations on the 3D printer. The thermal sensor 120 may include any of a variety of devices for detecting or reading a thermal characteristic such as temperature. In one example, the thermal sensor 120 includes a thermal array camera, such as a forward-looking infrared (FLIR) device (e.g., a FLIR camera). Thus, as the array of nozzles 110 deposits a layer of build material 150 onto the stage 140, the thermal sensor 120 may determine a thermal characteristic at multiple locations of the layer of build material 150. The locations at which the thermal characteristic is determined may be spaced apart based on various factors, such as the resolution of the thermal sensor 120. In one example, the resolution is sufficient to provide a temperature measurement corresponding to printing material (e.g., build material or fusing agent) deposited by an individual nozzle. Thus, in one row of material deposited by the array of nozzles 110, the thermal sensor 120 can obtain temperature measurements corresponding to printing material deposited by each nozzle in the array of nozzles 110.

The example system 100 of FIG. 1 further includes a controller 130. The controller 130 may be implemented as hardware, software, firmware or a combination thereof. In various examples, the controller 130 is a processor coupled to a 3D printer which includes the array of nozzles 110. In this regard, the controller 130 may be provided to control operation of various subsystems of the 3D printer and may include, for example, communication interface, storage device, etc.

In the example system 100 of FIG. 1, the controller 130 includes a gradient identification portion 132. The gradient identification portion 132 is provided to identify a location on the layer of build material 150 having a gradient of the thermal characteristic that is greater than a predetermined threshold. In this regard, the gradient identification portion 132 may obtain temperature measurements at the various locations on the layer of build material 150 and identify locations at which the temperature is different from surrounding or adjacent locations. While some variations in the temperature may be acceptable, a variation above a predetermined threshold may be considered anomalous. For example, in one example, a temperature variation within a threshold of 1° C., 1.5° C. or 2° C. may be acceptable, but a variation greater than the threshold may be indicative of an anomaly related to a nozzle. In this regard, the gradient identification portion 132 identifies a location at which the gradient of the thermal characteristic (e.g., temperature) is above the threshold.

Once the print material (e.g., the layer of build material 150 or the fusing agent) is deposited by the array of nozzles 110, the print material may cool (e.g., due to evaporation). Thus, the absolute temperature of the build material may be a changing value. Since the print material generally cools uniformly, using the gradient, or difference in temperature values at adjacent points, is an effective measure for identifying an anomaly. In this regard, in some examples, the gradient may be measured along a perpendicular axis (the Y axis) to the direction of movement of the carriage of nozzles (the X axis). For example, each nozzle or an array of nozzles may deposit material along a particular row, and a temperature difference between adjacent or neighboring rows may be used to identify the gradient.

The example system 100 of FIG. 1 further includes a nozzle identification portion 134 to identify a nozzle associated with the identified location as an anomalous nozzle. In this regard, the nozzle identification portion 134 may map the location identified by the gradient identification portion 132 as having a gradient greater than the predetermined threshold to a particular nozzle in the array of nozzles 110. In this regard, the distance along the Y axis perpendicular to the direction of movement of the carriage or nozzles (the X axis) may be used to identify the particular nozzle associated with the location identified by the gradient identification portion 132. The location of a sufficiently large gradient in the thermal characteristic is thus associated with an anomalous nozzle.

Referring now to FIG. 2, another example system 200 for anomalous nozzle determination is illustrated. The example system 200 is similar to the example system 100 described above with reference to FIG. 1 and includes an array of nozzles 210, a thermal sensor 220, and a controller 230. Similar to the example system 100 described above, the controller 230 of the example system 200 includes a gradient identification portion 232 and a nozzle identification portion 234. As noted above, the array of nozzles 210 is provided to deposit a printing material (e.g., build material or fusing agent) for printing a 3D object, and the thermal sensor 220 is provided to detect a thermal characteristic, such as temperature, at various locations of the layer of build material. The gradient identification portion 232 is provided to identify a location on a layer of build material, such as the build material 240, the identified location having a gradient of the thermal characteristic being greater than a predetermined threshold.

As noted above, as each layer of build material 240 is deposited, selected portions of the layer are fused to form the desired 3D object. FIG. 2 illustrates selected fused portions 242 in the layer of build material 240. The fusing of the select portions 242 may be achieved in various manners for different 3D printing technologies. For example, in an SLS printer, the select portions may be fused by application of energy (e.g., via laser) to the select portions 242. In an MJF printer, a fusing agent is deposited onto the select portions 242 of the layer of build material 240. In this regard, a second array of nozzles on a second carriage (not shown in FIG. 2) may be provided to deposit the fusing agent.

In some examples, the gradient identification portion 232 identifies the gradient as described above regardless of the location on the layer of build material 240. In this regard, the gradient identification portion 232 may consider measurement or detection by the thermal sensor 220 of the thermal characteristic across the entire layer of build material 240. In other examples, the gradient identification portion 232 is to identify the location of a gradient on the fused portions 242. In this regard, the gradient identification portion 232 may disregard the thermal characteristic at the non-fused portions.

Further, in some examples, the threshold at which the gradient triggers an indication of an anomaly may be constant across the entire layer of build material 240 or across all fused portions 242. In other examples, the threshold may be different at different regions of the layer of build material 240 or different regions of the fused portions 242. For example, certain regions of the 3D object being printed may be more important and have more stringent tolerances. In this regard, those critical regions may correspond to a lower threshold for the gradient, while other regions may have a higher threshold. In further examples, various portions may each have their own threshold. Thus, in various examples, a 3D printer or a 3D object printed on the 3D printer may have any number of thresholds associated with it.

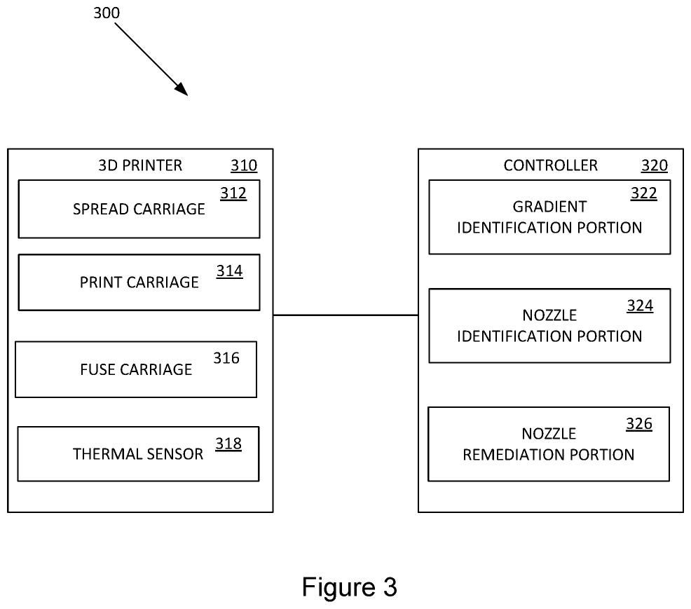

Referring now to FIG. 3, a block diagram of another example system 300 for anomalous nozzle determination is illustrated. The example system 300 includes a 3D printer 310 and a controller 320. As noted above, the 3D printer 310 may use any of a variety of 3D printing technologies. In one example, the 3D printer 310 is a multi jet fusion (MJF) printer. In this regard, the 3D printer 310 includes a spread carriage 312 to deposit build material. In this regard, the spread carriage 312 includes an array of nozzles which deposit a layer of the build material as the carriage scans across a build stage. The 3D printer 310 further includes a print carriage 314 to deposit a fusing agent. In various examples, the print carriage 314 is separate from the nozzle carriage 312. A fuse carriage 316 scans across the build stage and may apply energy (e.g., thermal energy) to cause fusing of the build material where the fusing agent has been deposited. Of course, in various examples, the functionality of two or more of the various carriages 312-316 may be combined on a common carriage. Further, the 3D printer 310 of the example system 300 is provided with a thermal sensor 318 similar to the thermal sensors 120, 220 described above with reference to FIGS. 1 and 2.

The controller 320 of the example system 300 includes a gradient identification portion 322 and a nozzle identification portion 324 similar to corresponding portions described above with reference to FIGS. 1 and 2. As noted above, the gradient identification portion 322 is to identify a location at which the gradient of the thermal characteristic is greater than a predetermined threshold. The nozzle identification portion 324 used the location identified by the gradient identification portion 322 to identify a corresponding nozzle from the array of nozzles in the spread carriage 312 or the print carriage 314. In this regard, the gradient above the threshold may be indicative of an anomaly associated with the corresponding nozzle. In this regard, the nozzle identification portion 324 indicates the corresponding nozzle as an anomalous nozzle.

The controller 320 of the example system 300 further includes a nozzle remediation portion 326. The nozzle remediation portion 326 is provided to initiate remediation of the anomalous nozzle identified by the nozzle indication portion 324. In this regard, remediation may include any of a variety of actions that may be initiated or completed by the nozzle remediation portion 326. Some examples of remediation actions are described below.

In one example, the nozzle remediation portion 326 may cause introduction of a replacement fusing agent at the location corresponding to the anomalous nozzle. For example, in an MJF 3D printer, the fusing agent deposited at the locations corresponding to the anomalous nozzle (e.g., location on the build material with gradient greater than the predetermined threshold) may be replaced with a low tint fusing agent (LTFA). LTFA has low thermal absorption in the visible spectrum and high thermal absorption in the near-infrared spectrum where there is significant amount of thermal energy absorbed. The LTFA may compensate for the anomaly in the nozzle and allow proper fusing of the build material.

In another example, the nozzle remediation portion 326 may generate an alert indicative of the anomalous nozzle. In various examples, the nozzle remediation portion 326 may generate an audible, visual, or other alert to notify a user of the anomalous nozzle. The user may provide maintenance or replacement service for the anomalous nozzle.

In another example, the nozzle remediation portion 326 may cause servicing or replacement of the anomalous nozzle. In this regard, the nozzle remediation portion 326 may initiate automated or robotic actions. In one example, the nozzle remediation portion 326 may cause servicing, such as spitting or wiping of the nozzle.

In another example, the nozzle remediation portion 326 may adjust indexing of passes of the array of nozzles. In this regard, the nozzle remediation portion 326 may cause or adjust shifting of the spread carriage 312 or the print carriage 314 for successive passes. Thus, the anomalous nozzle may pass deposit build material and/or fusing agent at different regions on successive passes, thereby diluting or otherwise mitigating the effects of the anomaly.

In another example, the nozzle remediation portion 326 may adjust use of nozzles adjacent to the anomalous nozzle. For example, the nozzle remediation portion 326 may cause the adjacent nozzles to output a greater amount of print material, while reducing or eliminating the amount of print material from the anomalous nozzle.

In another example, the nozzle remediation portion 326 may cause re-location of a fused portion corresponding to the anomalous nozzle to a different location. For example, the anomaly may be determined or detected during deposition of the first few layers of the build material. Upon determination or detection of the anomaly, the nozzle remediation portion 326 may re-position the printing of the 3D object upon the build stage, thus moving the printing of the 3D object to a location on the layer of build material or on the build stage that is not affected by the anomalous nozzle.

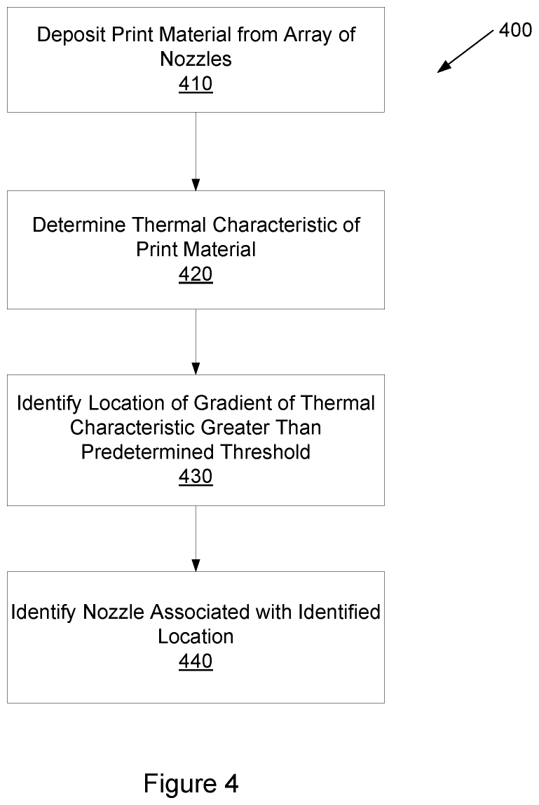

Referring now to FIG. 4, a flowchart illustrates an example method 400 for anomalous nozzle determination. The example method 400 may be implemented in any of a variety of systems, such as the example systems 100, 200, 300 described above with reference to FIGS. 1-3. The example method 400 includes depositing a print material from an array of nozzles for printing a three-dimensional object (block 410). The print material may be a layer of build material or a fusing agent at selected locations. As noted above, an array of nozzles may be mounted on a carriage that sweeps a build stage of a 3D printer and deposits successive layers of build material or fusing agent to fuse the build material at selected locations to form a 3D object.

The example method 400 further includes determining a thermal characteristic of the print material (block 420). As noted above, a thermal sensor may be mounted with the array of nozzles and may include any of a variety of devices for detecting or reading a thermal characteristic such as temperature.

The example method 400 includes identifying a location on the print material having a gradient of the thermal characteristic being greater than a predetermined threshold (block 430). As described above with reference to FIGS. 1-3, a gradient identification portion may be provided to identify a location on the layer of build material having a gradient of the thermal characteristic that is greater than a predetermined threshold. The gradient identification portion may obtain measurements (e.g., temperature measurements) at the various locations on the layer of build material and identify locations at which the temperature is different from surrounding or adjacent locations.

The example method 400 further includes identifying a nozzle from the array of nozzles associated with the identified location as an anomalous nozzle (block 440). Various example systems may include a nozzle identification portion to identify the nozzle associated with the identified location as the anomalous nozzle. The nozzle identification portion may map the location identified by the gradient identification portion as having a gradient greater than the predetermined threshold to a particular nozzle in the array of nozzles.

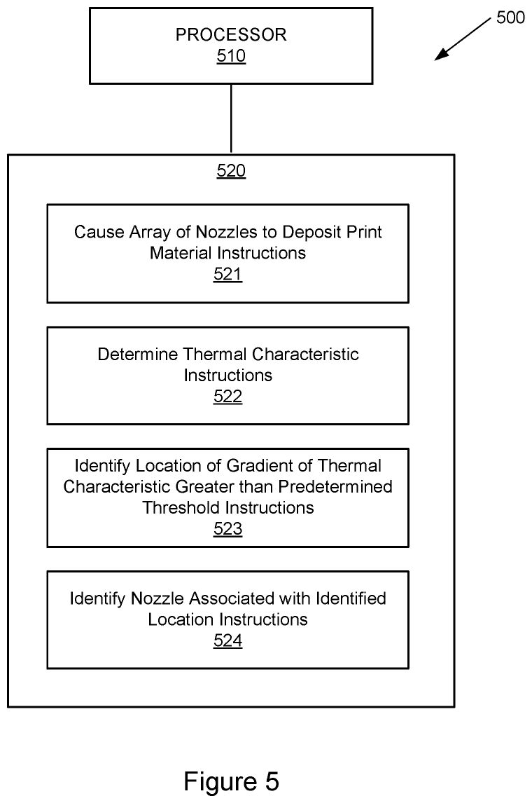

Referring now to FIG. 5, a block diagram of an example system 500 is illustrated with a computer-readable storage medium including instructions executable by a processor for anomalous nozzle determination. The system 500 includes a processor 510 and a non-transitory computer-readable storage medium 520. The computer-readable storage medium 520 includes example instructions 521-524 executable by the processor 510 to perform various functionalities described herein. In various examples, the non-transitory computer-readable storage medium 520 may be any of a variety of storage devices including, but not limited to, a random access memory (RAM) a dynamic RAM (DRAM), static RAM (SRAM), flash memory, read-only memory (ROM), programmable ROM (PROM), electrically erasable PROM (EEPROM), or the like. In various examples, the processor 510 may be a general purpose processor, special purpose logic, or the like. In various examples, the processor 510 may include or be included in the controller 130, 230, 320 of the example systems 100, 200, 300 described above with reference to FIGS. 1-3.

The example instructions include cause an array of nozzles to deposit a print material instructions 521. In various examples, an array of nozzles may be mounted on a carriage that sweeps a build stage of a 3D printer and deposits successive layers of print material (e.g., build material or a fusing agent to fuse the build material at selected locations to form a 3D object).

The example instructions further include determine a thermal characteristic of the print material instructions 522. A thermal sensor may be provided for detecting or reading a thermal characteristic such as temperature.

The example instructions further include identify a location on the layer of build material having a gradient of the thermal characteristic being greater than a predetermined threshold instructions 523. In various examples, a location on the layer of build material having a gradient of the thermal characteristic that is greater than a predetermined threshold may be identified based on measurements from the thermal sensor.

The example instructions further include identifying a nozzle from the array of nozzles associated with the identified location as an anomalous nozzle instructions 524. In various examples, the nozzle associated with the identified location may be indicated as the anomalous nozzle. The location identified by the gradient identification portion as having a gradient greater than the predetermined threshold may be mapped to a particular nozzle in the array of nozzles.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A system, comprising:
an array of nozzles to deposit a print material for printing a three-dimensional object;
a thermal sensor to determine a thermal characteristic at multiple locations of the print material; and
a controller including:
a gradient identification portion to identify at least one location on the layer of build material having a gradient of the thermal characteristic being greater than a predetermined threshold; and
a nozzle identification portion to identify at least one nozzle associated with the identified location as an anomalous nozzle.

2. The system of claim 1, wherein the gradient identification portion is to identify the location on a portion of a layer of print material to be fused.

3. The system of claim 1, wherein the controller further includes:
a nozzle remediation portion to initiate remediation of the anomalous nozzle.

4. The system of claim 3, wherein the remediation includes at least one of:
introducing a replacement fusing agent deposited at the identified location associated with the anomalous nozzle;
generating an alert indicative of the anomalous nozzle;
servicing or replacing the anomalous nozzle;
adjusting indexing of passes of the array of nozzles;
adjusting use of nozzles adjacent to the anomalous nozzle; or causing re-location of a fused portion corresponding to the anomalous nozzle to a different location.

5. The system of claim 4, wherein the replacement fusing agent is a low tint fusing agent.

6. The system of claim 1, wherein the predetermined threshold is a constant value for all locations on the print material.

7. The system of claim 1, wherein the predetermined threshold varies with location.

8. A method, comprising:
depositing a print material from an array of nozzles for printing a three-dimensional object;
determining a thermal characteristic of the print material;
identifying at least one location on the print material having a gradient of the thermal characteristic being greater than a predetermined threshold; and
identifying at least one nozzle from the array of nozzles associated with the identified location as an anomalous nozzle.

9. The method of claim 8, further comprising:
initiating remediation of the anomalous nozzle.

10. The method of claim 8, wherein the remediation includes at least one of:
introducing a replacement fusing agent deposited at the identified location associated with the anomalous nozzle;
generating an alert indicative of the anomalous nozzle;
servicing or replacing the anomalous nozzle;
adjusting indexing of passes of the array of nozzles;
adjusting use of nozzles adjacent to the anomalous nozzle; or
causing re-location of a fused portion corresponding to the anomalous nozzle to a different location.

11. The method of claim 10, wherein the replacement fusing agent is a low tint fusing agent.

12. A non-transitory computer-readable storage medium encoded with instructions executable by a processor of a computing system, the computer-readable storage medium comprising instructions to:
cause an array of nozzles to deposit a print material for printing a three-dimensional object;
determine a thermal characteristic of the print material;
identify a location on the print material having a gradient of the thermal characteristic being greater than a predetermined threshold; and
identify a nozzle from the array of nozzles associated with the identified location as an anomalous nozzle.

13. The non-transitory computer-readable storage medium of claim 12, further comprising instructions to:
initiate remediation of the anomalous nozzle.

14. The non-transitory computer-readable storage medium of claim 13, wherein the instructions to initiate remediation includes instructions to at least one of:
introduce a replacement fusing agent deposited at the identified location associated with the anomalous nozzle;
generate an alert indicative of the anomalous nozzle;
service or replacing the anomalous nozzle;
adjusting indexing of passes of the array of nozzles;
adjusting use of nozzles adjacent to the anomalous nozzle; or causing re-location of a fused portion corresponding to the anomalous nozzle to a different location.

15. The non-transitory computer-readable storage medium of claim 14, wherein the replacement fusing agent is a low thermal absorbing fusing agent.
